(19) United States
(12) Patent Application Publication
(10) Pub. No.: US 2009/0170946 A1
(43) Pub. Date: Jul. 2, 2009

(54) Composition for Mold Remediation

(76) Inventor: Vladimir Y. Podlipskiy, San Diego, CA (US)

Correspondence Address: NYDEGGER & ASSOCIATES, 348 OLIVE STREET, SAN DIEGO, CA, 92103, US

(21) Appl. No.: 12/343,250

(22) Filed: Dec. 23, 2008

Related U.S. Application Data
(60) Provisional application No. 61/017,115, filed on Dec. 27, 2007.

(51) Int. Cl. A01N 37/44; A01P 3/00

(52) U.S. Cl. 514/561

(57) ABSTRACT

An anti-fungal composition is disclosed and has enhanced microbiocidal activities for killing or inhibiting growth of live mold cells and spores. Further, the composition stops the production of mycotoxins associated with molds. Included among the molds vulnerable to the composition are black mold, Aspergillus fumigatus, Aspergillus flavus, Aspergillus niger, Stachybotrys chartarum, cladosporium species, fusarium species, and penicillium species In the composition, naturally-occurring compounds selected from the phenylpropanoid family and synthetic derivatives of compounds selected from the phenylpropanoid family are active against the live cells, spores, and mycotoxins. Further, the composition includes D-isomers of naturally-occurring aromatic amino acids and synthetic derivatives of D-isomers of naturally-occurring aromatic amino acids in order to kill and inhibit growth of the live cells, spores, and mycotoxins.

This application claims the benefit of U.S. Provisional Patent Application Ser. No. 61/017,115 filed Dec. 27, 2007.

### FIELD OF THE INVENTION

The present invention pertains generally to anti-microbial compositions and methods for their use. More particularly, the present invention pertains to anti-microbial compositions and methods for killing and inhibiting growth of fungal matter such as live cells and spores associated with molds. The present invention is particularly, but not exclusively, useful for providing anti-fungal compositions containing naturally-occurring compounds within the phenylpropanoid family, synthetic derivatives of compounds within the phenylpropanoid family, D-isomers of naturally-occurring aromatic amino acids and/or synthetic derivatives of D-isomers of naturally-occurring aromatic amino acids to kill and inhibit growth of live cells and spores associated with molds.

### BACKGROUND OF THE INVENTION

Molds include all species of microscopic fungi that grow in the form of multicellular filaments, called hyphae. Molds do not form a specific taxonomic or phylogenetic grouping, but can be found in the divisions Zygomycota, Deuteromycota and Ascomycota. There are thousands of known species of molds, which include opportunistic pathogens, exclusive saprotrophs, aquatic species and thermophiles. Like all fungi, molds derive energy not through photosynthesis but from the organic matter on which they live.

In order to reproduce, molds create spores that can be carried by air currents. When these spores land on a surface they need only three things to grow into mold: nutrients, moisture, and time. Due to their size, some spores can remain airborne indefinitely and mold spores are a common component of household and workplace dust. When mold spores are present in large quantities, they can present a health hazard to humans.

Health problems associated with high levels of airborne mold spores include allergic reactions, asthma episodes, irritations of the eye, nose and throat, infections, sinus congestion, and other respiratory problems. When inhaled, mold spores may germinate, attaching to cells along the respiratory tract and causing further problems in those with weak immune systems.

After landing on a surface, spores can grow into mold almost anywhere moisture is present. As a result, molds are found virtually everywhere, whether indoors or outside. Food sources for molds include cellulose-based materials, such as wood, cardboard, and paper facing on drywall, and all other kinds of organic matter, such as soap, dust and fabrics.

Because common building materials are capable of sustaining mold growth, mold growth in an indoor environment typically indicates a water or moisture problem. Leaky roofs, building maintenance problems, or indoor plumbing problems can lead to mold growth inside homes, schools, or office buildings. Another common source of mold growth is flooding.

After a single incident of water damage occurs in a building, molds grow inside walls and then can become dormant until a subsequent incident of high humidity. Specifically, when conditions do not enable growth, molds can remain alive for a significant duration of time in a dormant state, within a large range of temperatures before eventually dying.

Many molds also secrete mycotoxins which inhibit the growth of competing microorganisms. Importantly, some of these mycotoxins pose serious health risks to humans and animals. In fact, exposure to high levels of certain mycotoxins can lead to neurological problems and in some cases death. The phrase “toxic mold” refers to molds that produce mycotoxins and not to all molds in general. Human bodies can tolerate mycotoxins in small quantities and immune system reactions to mycotoxins vary, but include chronic fatigue and irritability, flu-like symptoms, respiratory problems, headaches, cognitive problems, and skin problems.

In the 1970s, building construction techniques changed and resulted in homes and buildings becoming more air-tight, and, thus, more humid. Also, materials such as drywall came into common use. This combination of increased moisture and suitable substrates contributed to increased mold growth inside buildings. It has been estimated that forty percent of United States homes have some form of mold problem.

Significant mold growth may require professional mold remediation and removal of affected building materials. In extreme cases of mold growth in buildings, it may be easier to condemn the building rather than clean the mold to safe levels. Typically, the first step in solving an indoor mold problem is stopping the source of moisture. Next is to remove the mold growth.

Common remedies for small occurrences of mold include sunlight, ventilation, installation of non-porous building materials, and the use of bleach to kill live cells. However, bleach has been ineffective in killing spores.

The most common genus of fungi is Aspergillus. Of particular importance, are the species Aspergillus fumigatus, Aspergillus flavus, and Aspergillus niger. Exposure to spores from Aspergillus fumigatus in humans often results in severe allergic reactions. Further, Aspergillus flavus produces the mycotoxin aflatoxin which is one of the most potent carcinogens known to man. Also, Aspergillus niger often actively proliferates in the human lung, forming a ball. Another common type of toxic mold is Stachybotrys chartarum, which produces extremely toxic, carcinogenic and immunosuppressive mycotoxins. Other dangerous toxic molds include cladosporium species, fusarium species, and penicillium species.

In light of the above, it is an object of the present invention to provide anti-microbial compositions and methods for killing and/or inhibiting growth of fungal matter such as live cells and spores associated with molds. Another object of the present invention is to provide a composition for stopping the production of mycotoxins. Another object of the present invention is to provide an improved anti-fungal composition containing synthetic derivatives of compounds within the phenylpropanoid family. Yet another object of the present invention is to provide an anti-fungal composition containing naturally-occurring compounds within the phenylpropanoid family. Still another object of the present invention is to provide an anti-fungal composition containing D-isomers of naturally-occurring aromatic amino acids. Yet another object of the present invention is to provide an anti-fungal composition containing synthetic derivatives of D-isomers of naturally-occurring aromatic amino acids. Another object of the present invention is to provide an anti-fungal composition that is easy to use, simple to manufacture and comparatively cost effective.

### SUMMARY OF THE INVENTION

The present invention provides a composition and method for the purpose of killing and/or inhibiting growth of fungal matter such as live cells and spores associated with molds. Importantly, the effects of the composition on live cells and spores cause fungal production of mycotoxins to cease.

### DESCRIPTION OF THE PREFERRED EMBODIMENTS

For fungicidal purposes, the composition includes naturally-occurring compounds selected from the phenylpropanoid family with molecular weights (MW) ranging from about 100 to about 400 g/mol. Also, the composition includes synthetic (chemically-modified) derivatives of compounds selected from the phenylpropanoid family with MW ranging from about 150 to about 1400 g/mol.

It is noted that phenylpropanoids are a class of plant-derived organic compounds that are biosynthesized from the amino acid phenylalanine. For instance, cinnamic acid is created from phenylalanine by the action of the enzyme phenylalanine ammonia lysase (PAL). A series of enzymatic hydroxylations and methylations leads to coumaric acid, caffeic acid, ferulic acid, 5-hydroxyferulic acid, and sinapic acid. Conversion of these acids to their corresponding esters produces some of the volatile components of herb and flower fragrances.

Also, cinnamic aldehydes may be formed by the reduction of the carboxylic acid functional groups in the cinnamic acids. Further reduction provides monolignols including coumaryl alcohol, coniferyl alcohol, and sinapyl alcohol. The monolignols are monomers that may be polymerized to generate various forms of lignin and suberin, which are used as a structural component of plant cell walls. The phenylpropenes, including eugenol, chavicol, safrole and estragole, may be derived from the monolignols. These compounds are the primary constituents of various essential oils.

Hydroxylation of cinnamic acid in the 2-position leads to p-coumaric acid, which can be further modified into hydroxylated derivatives such as umbelliferone. Another use of p-coumaric acid via its thioester with coenzyme A, i.e. 4-coumaroyl-CoA, is the production of chalcone. This is achieved with the addition of 3 malonyl-CoA molecules and their cyclization into a second phenyl group (see polyphenols). Chalcone is the precursor of all flavonoids, a diverse class of phytochemicals. Stilbenoids, such as resveratrol, are hydroxylated derivatives of stilbene. They are formed through an alternative cyclization of cinammoyl-CoA or 4-coumaroyl-CoA.

In addition, the composition includes the D-isomers of naturally-occurring aromatic amino acids with MW ranging from about 150 to about 250 g/mol. D-isomers of aromatic amino acid include dextrothyroxine, D-phenylalanine (DPA), D-tryptophan, and D-tyrosine, among others.

As a final active ingredient, the composition includes synthetic (chemically-modified) derivatives of D-isomers of naturally-occurring aromatic amino acids with MW ranging from about 160 to about 700 g/mol. For the present invention, each of the active ingredients may have anti-sporulation, anti-mold, and/or anti-mycotoxin properties.

In addition to the active constituents, the composition includes inert ingredients for preparation, storage and/or application reasons. In the composition, surfactants may have a total concentration in the composition of less than about 1.5%. Specifically, the surfactants may include alkyl polyglycoside surfactants. Also, the inert ingredients include a vitamin combination having a total concentration in the composition of less than about 0.1%. Preferably, the vitamin combination includes vitamin A, vitamin E, and vitamin C.

During application of the composition onto a surface, the active ingredients kill fungal matter such as live cells and spores. As a result, the immediate production of mycotoxins associated with molds ceases. Further, the composition is able to penetrate into the surface and reside on the surface and in pores near the surface for a period of time as long as the lifetime of the surface material. Because the naturally occurring compounds selected from the phenylpropanoid family and their synthetic derivatives have long term preventive effects against mold growth, absorption of these active ingredients into the surface inhibits future growth of fungal matter such as live cells and spores. As a result, future production of mycotoxins associated with molds is made impossible at and near the surface. For example, when a surface that has no fungal matter, whether live cells or spores, is treated with the composition the surface becomes resistant to mold even if millions of spores and/or live cells are inoculated on it.

In the method of killing and inhibiting growth of live mold cells and spores, the synthetic derivatives of compounds selected from the phenylpropanoid family are created. Also, the synthetic derivatives of D-isomers of naturally-occurring aromatic amino acids are created. Thereafter, the synthetic derivatives of compounds selected from the phenylpropanoid family are mixed with the synthetic derivatives of D-isomers of naturally-occurring aromatic amino acids, as well as with naturally-occurring compounds selected from the phenylpropanoid family, D-isomers of naturally-occurring aromatic amino acids and inert ingredients. Then, the resulting mixture is diluted with water to produce an anti-fungal composition with enhanced microbiocidal activities. After the composition is produced, it may be applied to a surface through spraying, pouring, misting, or the like.

While the particular Composition for Mold Remediation as herein shown and disclosed in detail is fully capable of obtaining the objects and providing the advantages herein before stated, it is to be understood that it is merely illustrative of presently preferred embodiments of the invention and that no limitations are intended to the details of composition herein described other than as defined in the appended claims.

What is claimed is:

1. An anti-fungal composition with enhanced microbiocidal activities for killing and inhibiting growth of live mold cells and spores associated with mold comprising:
at least one naturally-occurring compound selected from the phenylpropanoid family;
a synthetic derivative of at least one compound selected from the phenylpropanoid family;
a D-isomer of at least one naturally-occurring aromatic amino acid;
a synthetic derivative of at least one D-isomer of naturally-occurring aromatic amino acids; and
at least one inert ingredient.

2. A composition as recited in claim 1 wherein the naturally-occurring compounds selected from the phenylpropanoid family have a molecular weight between about 100 and about 400 g/mol, the synthetic derivatives of compounds selected from the phenylpropanoid family have a molecular weight between about 150 and about 1400 g/mol, the D-isomers of naturally-occurring aromatic amino acids have a molecular weight between about 150 and about 250 g/mol, and the synthetic derivatives of D-isomers of naturally-occurring aromatic amino acids have a molecular weight between about 160 and about 700 g/mol.

3. A composition as recited in claim 2 wherein the inert ingredients comprise surfactants having a total concentration in the composition of less than about 1.5%.

4. A composition as recited in claim 3 wherein the surfactants comprise alkyl polyglycoside.

5. A composition as recited in claim 3 wherein the inert ingredients comprise a vitamin combination having a total concentration in the composition of less than about 0.1%.

6. A composition as recited in claim 5 wherein the vitamin combination comprises vitamin A, vitamin E, and vitamin C.

7. A composition as recited in claim 1 wherein the mold is selected from the group consisting of black mold, Aspergillus fumigatus, Aspergillus flavus, Aspergillus niger, Stachybotrys chartarum, cladosporium species, fusarium species, and penicillium species.

8. A composition as recited in claim 1 wherein the live mold cells and spores are prevented from producing mycotoxins.

9. A method of killing and inhibiting growth of live mold cells and spores comprising the steps of:
creating a synthetic derivative of at least one compound selected from the phenylpropanoid family;
creating a synthetic derivative of a D-isomer of at least one naturally-occurring aromatic amino acid;
mixing the synthetic derivatives of compounds selected from the phenylpropanoid family, the synthetic derivatives of D-isomers of naturally-occurring aromatic amino acids, naturally-occurring compounds selected from the phenylpropanoid family, at least one D-isomer of a naturally-occurring aromatic amino acid and at least one inert ingredient to form a mixture;
diluting the mixture to produce an anti-fungal composition with enhanced microbiocidal activities; and
applying the composition to a surface.

10. A method as recited in claim 9 wherein the naturally-occurring compounds selected from the phenylpropanoid family have a molecular weight between about 100 and about 400 g/mol, the synthetic derivatives of compounds selected from the phenylpropanoid family have a molecular weight between about 150 and about 1400 g/mol, the D-isomers of naturally-occurring aromatic amino acids have a molecular weight between about 150 and about 250 g/mol, and the synthetic derivatives of D-isomers of naturally-occurring aromatic amino acids have a molecular weight between about 160 and about 700 g/mol.

11. A method as recited in claim 10 wherein the inert ingredients comprise surfactants having a total concentration in the composition of less than about 1.5%.

12. A method as recited in claim 11 wherein the surfactants comprise alkyl polyglycoside.

13. A method as recited in claim 11 wherein the inert ingredients comprise a vitamin combination having a total concentration in the composition of less than about 0.1%.

14. A method as recited in claim 13 wherein the vitamin combination comprises vitamin A, vitamin E, and vitamin C.

15. A method as recited in claim 9 wherein the mold is selected from the group consisting of black mold, Aspergillus fumigatus, Aspergillus flavus, Aspergillus niger, Stachybotrys chartarum, cladosporium species, fusarium species, and penicillium species.

16. A method as recited in claim 9 wherein the live mold cells and spores are prevented from producing mycotoxins.

17. A water-soluble composition for killing and inhibiting growth of live mold cells and spores associated with mold consisting of:
at least one naturally-occurring compound selected from the phenylpropanoid family;
a synthetic derivative of at least one compound selected from the phenylpropanoid family;
a D-isomer of at least one naturally-occurring aromatic amino acid; and
a synthetic derivative of at least one D-isomer of naturally-occurring aromatic amino acids.

18. A composition as recited in claim 17 wherein the naturally-occurring compounds selected from the phenylpropanoid family have a molecular weight between about 100 and about 400 g/mol, the synthetic derivatives of compounds selected from the phenylpropanoid family have a molecular weight between about 150 and about 1400 g/mol, the D-isomers of naturally-occurring aromatic amino acids have a molecular weight between about 150 and about 250 g/mol, and the synthetic derivatives of D-isomers of naturally-occurring aromatic amino acids have a molecular weight between about 160 and about 700 g/mol.

19. A composition as recited in claim 18 wherein the mold is selected from the group consisting of black mold, Aspergillus fumigatus, Aspergillus flavus, Aspergillus niger, Stachybotrys chartarum, cladosporium species, fusarium species, and penicillium species.

20. A composition as recited in claim 19 wherein the live mold cells and spores are prevented from producing mycotoxins.
